(19) United States
(12) Patent Application Publication
(10) Pub. No.: US 2010/0208551 A1
(43) Pub. Date: Aug. 19, 2010

(54) CONFIGURING WIRELESS SEISMIC ACQUISITION NETWORKS

(76) Inventors: Daniel Golparian, Oslo (NO); Anh Duc Dao, Oslo (NO)

Correspondence Address: WesternGeco L.L.C.;Kevin McEnaney, IP Dept, 10001 Richmond Avenue, HOUSTON, TX, 77042-4299, US

(21) Appl. No.: 12/370,780

(22) Filed: Feb. 13, 2009

(51) Int. Cl. G01V 1/22

(52) U.S. Cl. 367/77; 702/14; 702/188

(57) ABSTRACT

Described herein are implementations of various technologies for a method for configuring a wireless seismic acquisition network. A plurality of seismic receivers may be positioned over a survey area in a fixed pattern. A first message may be received from the receivers. The first message may indicate one or more base stations that are available for transferring seismic data from the receivers to a recording system. A second message may be received from the base stations. The second message may indicate a maximum number of receivers for which each of the base stations can transfer seismic data. One of the base stations may be assigned to each receiver without exceeding the maximum number.

### BACKGROUND

1. Field of the Invention

Implementations of various technologies described herein generally relate to methods and systems for configuring a wireless seismic acquisition network.

2. Description of the Related Art

The following descriptions and examples are not admitted to be prior art by virtue of their inclusion within this section.

Land-based seismic data acquisition systems typically include many seismic receivers that number from the thousands to hundreds of thousands. The receivers may acquire seismic data, and then send the data to a centralized system that collects the data. Typically, this centralized system is a recording truck. The receivers may send the data to the recording truck through a network. Similar to a telecommunications network, a seismic data acquisition network may have concentrators, or base stations, which route data from the receivers to the recording truck.

Traditionally, land-based seismic data acquisition networks are wire-based, which may be connected by copper wire, fiber-optic cables and the like. Wire-based networks are inherently problematic in ways that decrease operational time of the network, and increase the cost of seismic acquisition. For example, communication over cable may be detrimentally affected by problems such as cut wires. With communication failures, operational costs may increase due to the need to repeat shots in a seismic survey and personnel costs may increase for down time on the network. The hiring of personnel to maintain and repair the networks may also increase. Therefore, it may be desirable to implement the seismic data acquisition network as a wireless network.

Cellular-like architecture is often used for large networks. A number of wireless base stations are distributed to cover the survey area. Each base station has a limited transmission power and is planned to cover a small area called cell. Cell size is calculated approximately and actual cells differ from planned cells. The reason is that radio propagation from a base station to a receiver depends on their heights and the environment between and around them. Neighbor cells intersect. A receiver may hear from different base stations. An algorithm is needed to assign a base station to each receiver.

Typically, distributed algorithms are used for mobile phones in telecommunication networks such as, cellular networks. Distributed algorithms may be run by the mobile phones themselves to select the base station with highest signal strength. Distributed algorithms may be suitable for mobile, dynamic applications where a quick solution is desired.

However, using distributed algorithms in a stationary network, like a seismic data acquisition network, may make selections unpredictable. For example, a receiver in a planned cell may receive stronger signals from base stations of other cells than the base station of its planned cell due to radio propagation conditions. In such a case, the number of receivers associated with a base station may be unpredictable.

The unpredictability may become more problematic for applications in which a thorough site survey is not accomplished. In such a case, cell size may only be informative. Furthermore, each base station may have a limited capacity, i.e., each base station may only be able to handle a limited number of receivers. The limited capacity may be due to bandwidth resources or processing power. Adding extra capacity to base stations to address the limited capacity may not be feasible if system bandwidth is limited. Further, adding processing power may drive up costs of an extensive network.

### SUMMARY

Described herein are implementations of various technologies for a method for configuring a wireless seismic acquisition network. A plurality of seismic receivers may be positioned over a survey area in a fixed pattern. A first message may be received from the receivers. The first message may indicate one or more base stations that are available for transferring seismic data from the receivers to a recording system. A second message may be received from the base stations. The second message may indicate a maximum number of receivers for which each of the base stations can transfer seismic data. One of the base stations may be assigned to each receiver without exceeding the maximum number.

In another implementation, a system for acquiring seismic data may include a plurality of seismic receivers, one or more base stations, and a configuration station. The configuration station may include a processor, and a memory. The memory may contain computer-executable instructions. The computer-executable instructions may be executed by the processor. When executed by the processor, the computer-executable instructions may cause the configuration station to receive a first message from the receivers. The first message may indicate one or more base stations that are available for transferring seismic data from the receivers to a recording system. The first message may also indicate a link quality of the base stations.

In such an implementation, when executed by the processor, the computer-executable instructions may cause the configuration station to receive a second message from the base stations. The second message may indicate a maximum number of the receivers for which each of the base stations can transfer seismic data.

Additionally, when executed by the processor, the computer-executable instructions may cause the configuration station to assign one of the base stations to each receiver without exceeding the maximum number, and assign the base stations to the receivers such that a sum of link qualities between all the receivers and their assigned base stations is maximized;

The base stations may be assigned by formulating the assignment as a combinatorial optimization problem. The combinatorial optimization problem may have a first constraint, a second constraint, a first objective, and a second objective. The first constraint may include assigning the one of the base stations to each receiver. The second constraint may include avoiding exceeding the maximum number for the one of the base stations. The first objective may include fulfilling the first constraint and the second constraint. The second objective may include assigning the receivers.

The first objective and the second objective may be fulfilled by using one or more binary linear programming algorithms comprising constraints

$${\sum }_{j \vert {X}_{ij ∈ S}} {X}_{ij} = 1 ,$$

for all i from 1 to Nₜ, constraints

$${\sum }_{i \vert {X}_{ij ∈ S}} {X}_{ij} \leq {C}_{j} ,$$

for all j from 1 to N_{b}, and an objective function to maximize Σ_{i,j|X}_{ᵢⱼ}_{εS} qᵢⱼXᵢⱼ. In the binary linear programming algorithms, i may be an index that identifies one of the receivers, and j may be an index that identifies one of the base stations. Xᵢⱼ may be a binary variable with a value of 1 when a base station j 1 is assigned to a receiver i, and a value of 0 when the base station j is not assigned to the receiver i. Nₜ may be a number of the receivers. N_{b} may be a number of the base stations. Cⱼ may be the maximum number for base station j. S may be a set of all potential assignments between the receivers and their available base stations. Z may be the sum of the link qualities. Further, qᵢⱼ may be a link quality between the receiver i and the base station j.

In another implementation, one or more wireless signals may be received from one or more base stations. The base stations may be disposed in a fixed pattern over a seismic survey area. One or more of the wireless signals that exceed a predetermined link quality threshold may be determined. A first message may be sent to a configuration station. The first message may indicate the base stations corresponding to the one or more of the wireless signals that exceed the predetermined link quality threshold. A second message may be received from the configuration station. The second message may indicate a selection of one of the base stations corresponding to the one or more of the wireless signals that exceed the predetermined link quality threshold.

The claimed subject matter is not limited to implementations that solve any or all of the noted disadvantages. Further, the summary section is provided to introduce a selection of concepts in a simplified form that are further described below in the detailed description section. The summary section is not intended to identify key features or essential features of the claimed subject matter, nor is it intended to be used to limit the scope of the claimed subject matter.

### BRIEF DESCRIPTION OF THE DRAWINGS

Implementations of various technologies will hereafter be described with reference to the accompanying drawings. It should be understood, however, that the accompanying drawings illustrate only the various implementations described herein and are not meant to limit the scope of various technologies described herein.

FIG. 1 illustrates a wireless land-based seismic data acquisition system of a survey area in accordance with implementations described herein.

FIG. 2 illustrates neighboring base stations in a cellular network in accordance with implementations described herein.

FIG. 3 illustrates a flow chart of a method for configuring a wireless seismic data acquisition network in accordance with implementations described herein.

FIG. 4 illustrates a flow chart of a method for assigning the base station to the receiver in accordance with implementations described herein.

FIG. 5 illustrates a data flow diagram of a method for configuring the wireless seismic data acquisition network in accordance with implementations described herein.

FIG. 6 illustrates a configuration station into which implementations of various technologies described herein may be implemented.

### DETAILED DESCRIPTION

The discussion below is directed to certain specific implementations. It is to be understood that the discussion below is only for the purpose of enabling a person with ordinary skill in the art to make and use any subject matter defined now or later by the patent “claims” found in any issued patent herein.

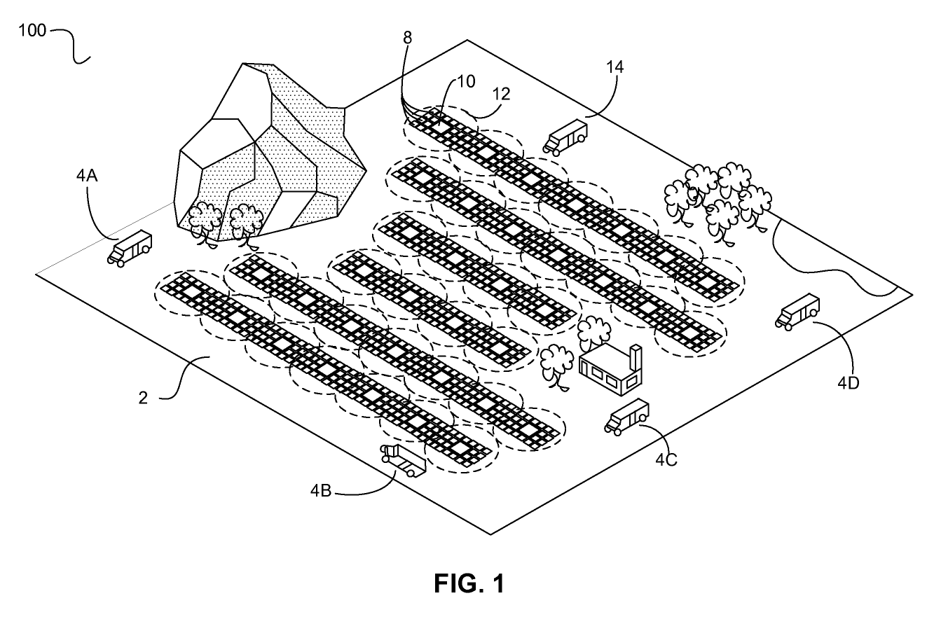

The following paragraph provides a brief summary of various techniques described herein. In general, various techniques described herein are directed to configuring wireless seismic acquisition networks. One or more implementations of those techniques will now be described in more detail with reference to FIGS. 1-6 in the following paragraphs.

FIG. 1 illustrates a wireless land-based seismic data acquisition system 100 of a survey area 2 in accordance with implementations described herein. The system 100 may include seismic sources 4A-4D, receivers 8 laid in a specific pattern (parallel rows), base stations 10, and a recording truck 14.

Typically, seismic data acquisition systems aim to capture information about acoustic and elastic energy that propagates through the subsurface of the survey area 2. This energy may be generated by one or more of the seismic sources 4. In one implementation, the seismic sources 4 may be vibratory sources (vibrators). The vibrators may produce a pressure signal that propagates through the earth into the various subsurface layers of the survey area 2. In this manner, elastic waves may be formed through interaction with the geologic structure in the subsurface layers.

Elastic waves may be characterized by a change in local stress in the subsurface layers and a particle displacement, which is essentially in the same plane as the wavefront. Acoustic and elastic waves may also be known as pressure and shear waves. Acoustic and elastic waves may also be collectively referred to as the seismic wavefield.

The structure in the subsurface may be characterized by physical parameters such as density, compressibility and porosity. A change in the value of these parameters is referred to as an acoustic or elastic contrast and may be indicative of a change in subsurface layers, which may contain hydrocarbons. When an acoustic or elastic wave encounters an acoustic or elastic contrast, some part of the waves will be reflected back to the surface and another part of the wave will be transmitted into deeper parts of the subsurface. The elastic waves that reach the land surface may be measured by the receivers 8. The receivers 8 may measure seismic data, such as displacement, velocity, and acceleration. Examples of receivers 8 may include geophones, accelerometers, and the like.

The measurement of elastic waves at the land surface may be used to create a detailed image of the subsurface including a quantitative evaluation of the physical properties such as density, compressibility, porosity, etc. This is achieved by appropriate processing of the seismic data at a data center (not shown).

The seismic data may be transferred to the data center by the recording truck 14. The receivers 8 may send the seismic data to the recording truck 14 over a wireless network. To this end, each receiver 8 may have a base station 10 assigned thereto. The receivers 8 may send the seismic data to their assigned base stations 10 over a wireless link. In turn, the base stations 10 may transfer the seismic data to the recording truck 14.

The base stations 10 may be placed in the survey area 2 in a fixed pattern. Similarly, a number of receivers 8 may be placed in a fixed pattern around each base station 10. The number of receivers 8 placed around each base station 10 may vary widely according to the goals of the seismic survey.

Circles 12 indicate the approximate range of reception for each base station 10. This range may be the same or different for each base station 10. The circles 12 indicating the coverage area of the base stations may be referred to as cells 12, and the receivers 8 may be referred to as terminals.

As shown, the cells 12 may overlap for neighboring base stations 10. The cells 12 may be assumed to cover a certain area. The terminals may be positioned within the assumed coverage areas for their respective base stations 10. However, because actual range of communication depends on radio propagation environment between base stations and terminals, the assumed coverage area may not always be the same as the actual coverage area. Consequently, some terminals may end up in the actual coverage areas of more than one base station 10.

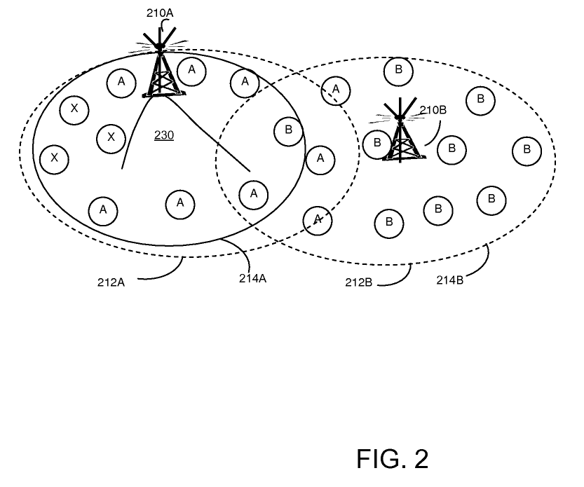

For example, referring to FIG. 2, a base station 210A may neighbor a base station 210B. Each base station 210A, 210B may have an assumed coverage area 214A, 214B. The terminals may be positioned within the assumed coverage areas 214A, 214B of their respective base stations 210A, 210B.

In the case of the base station 210B, the actual coverage area 212B may be the same as the assumed coverage area 214B. However, the base station 210A may be located on a hill 230. Consequently, the actual coverage area 212A may be larger than the assumed coverage area 214A. As such, some of the terminals positioned within the assumed coverage area 214B, while in the actual coverage area 212B, may also be in the actual coverage area 212A.

Terminals may have base stations 10 assigned to them based on different criteria. For example, terminals within a cell 12 may assign themselves the base station 10 having the strongest signal to the terminals, as in wireless telephony networks. Terminals in both of the actual coverage areas 212A, 212B may have signals from both base stations 210A, 210B. Consequently, some of the terminals in the planned coverage area for base station 210B may assign themselves base station 210A.

It should be noted that base stations 210A, 210B may each have a capacity to transfer seismic data only for the terminals in their respective planned cells 214A, 214B. If terminals in the planned coverage area 214B assign themselves to the base station 210A, the base station 210A may not have the capacity to transfer seismic data from all the terminals in the planned coverage area 214A. Consequently, some terminals in the planned coverage area 214A may not have the base station 210A assigned to them. If these terminals are located far away from base station 210B, they may not have enough transmission power to reach base station 210B. In such a scenario, some of the terminals in the planned coverage area 214A may not have either of the base stations 210A, 210B assigned. Further, in such a scenario, the base station 210B may be underused because the capacity is not used by all the terminals in the planned coverage area 214B.

For example, referring to FIG. 2, each of the actual coverage areas 212A, 212b may contain a number of terminals, labeled here as “A,” “B,” and “X.” Each label indicates the base station 210 that is assigned to that terminal. The terminals labeled, “X” may not have any base stations 210 assigned.

In one implementation, the recording truck may also include a configuration station that configures the wireless seismic data acquisition network to avoid the scenario described above. As such, the configuration station may communicate with the terminals and the base stations 10 to determine assignments for the entire network.

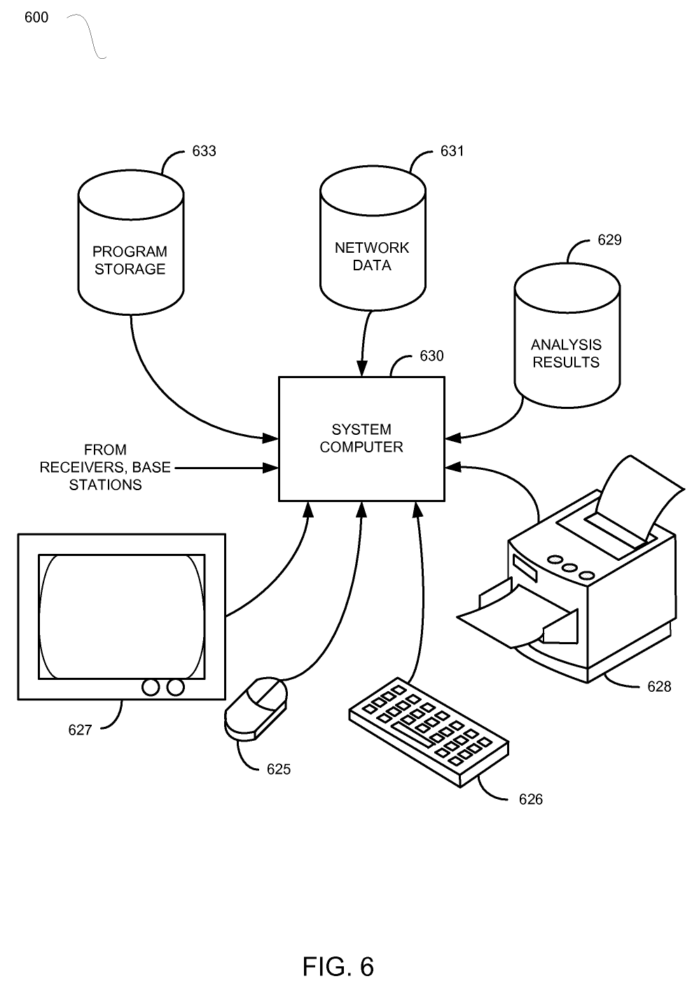

Various components of the configuration station are described in greater detail with reference to FIG. 6. Each terminal may have one base station 10 assigned without exceeding the capacity of the base stations 10. Further, under usage of the base stations 10 may be minimized.

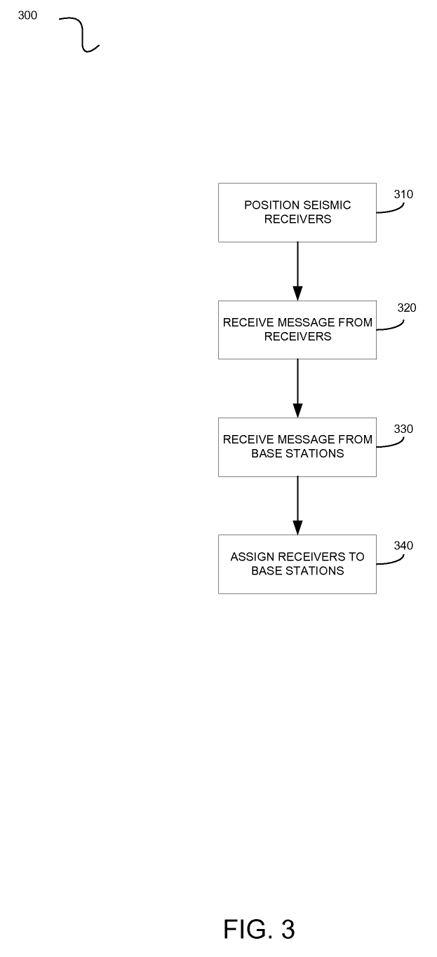

FIG. 3 illustrates a flow chart of a method 300 for configuring a wireless seismic data acquisition network in accordance with implementations described herein. In one implementation, method 300 may be performed by the configuration station. Although method 300 is described in a particular order, it should be understood that the various steps described in method 300 may be performed in any order. At step 310, the receivers 8 may be positioned over the survey area 2 in a fixed pattern.

At step 320, the configuration station may receive a message from each of the receivers 8. The message may indicate the base stations 10 that are available for transferring seismic data from the receivers 8 to the recording truck 14 and the link quality of these base stations. Link quality is a metric that indicates how good the link may be between the base station 210 and the receiver 8. In one implementation, the link quality may be the signal strength. In another implementation, the link quality may be the bit-error-rate, i.e., the percentage of erroneous bits).

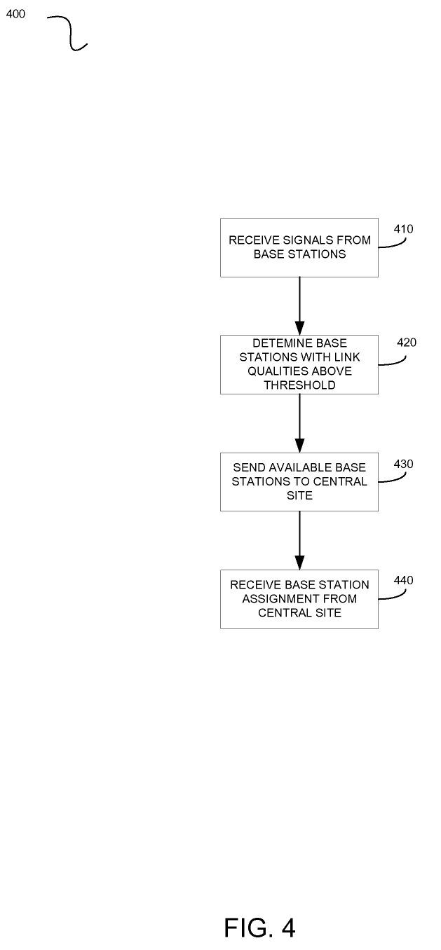

In one implementation, the receivers 8 may measure the link quality of all base stations with a signal to the receivers 8. In such an implementation, the base stations may periodically broadcast their identities. The receivers 8 may listen for a long enough period of time to receive all the broadcasts from the surrounding base stations 10. The receivers 8 may then measure the signal qualities from the broadcasts, and send the above described message to the configuration station. This message from the receivers 8 indicating the available base stations 10 for each receiver 8 is described in greater detail with respect to FIG. 4.

In another implementation, the receivers 8 may temporarily associate to each base station 10 from which the receiver 8 receives a signal and send a message indicating the base station 10 and the link quality to the base station 10. The base station 10 may then forward the message to the configuration station.

In another implementation, the receiver 8 may temporarily associate to the base station 10 and send the receiver's identity to the base station 10. The base station may measure the link quality from the receiver 8. The base station may then send a list of potential receivers 8 together with signal qualities to the configuration station.

At step 330, the configuration station may receive a message from each of the base stations 10. The message may indicate the capacity for the base stations 10. In one implementation, the capacity may be a maximum number of receivers 8 for which the base station 10 can transfer seismic data. The message from the base stations 10 is described in greater detail with respect to FIG. 4.

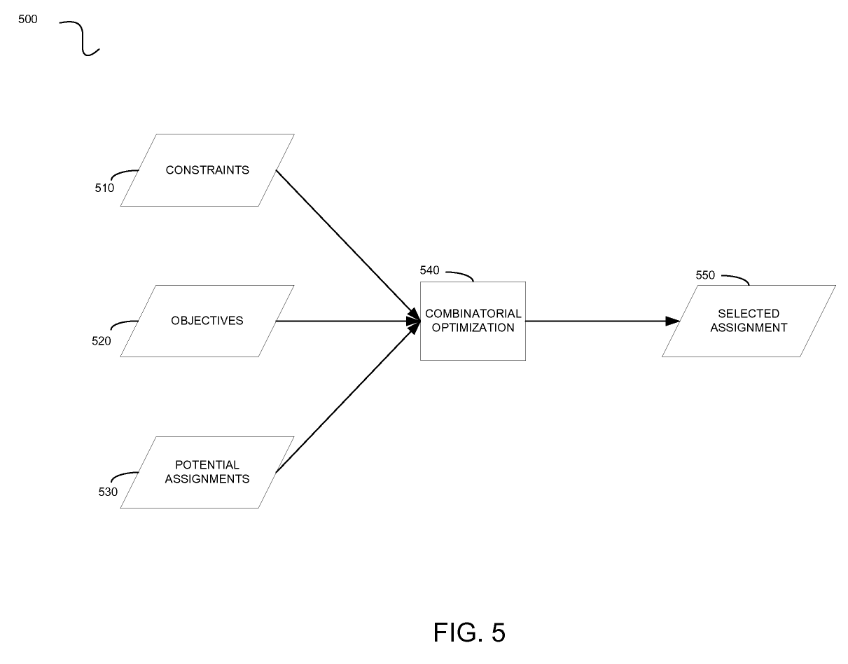

At step 340, the configuration station may assign the base stations 10 to the receivers 8. Each receiver 8 may have only one base station 10 assigned. Further, the assignment may limit the number of receivers 8 to which any base station 10 may be assigned. The limit may be the capacity of the base station 10. In other words, the number of receivers 8 to which the base station 10 may be assigned may not exceed the maximum number of receivers 8 for which the base station 10 can transfer seismic data. The assignment is described in greater detail with respect to FIGS. 4-5.

FIG. 4 illustrates a flow chart of a method 400 for assigning the base station 10 to the receiver 8 in accordance with implementations described herein. In one implementation, method 400 may be performed by the receiver 8. Although method 400 is described in a particular order, it should be understood that the various steps described in method 400 may be performed in any order.

At step 410, the receiver 8 may receive wireless signals from one or more base stations 10. As stated previously, the receiver 8 may measure the link quality of these signals.

At step 420, the receiver 8 may determine which base stations 10 have signals with link quality greater than a pre-determined threshold. The pre-determined threshold may be used to determine which base stations 10 are available for transferring seismic data from the receivers 8 to the recording truck 14. The pre-determined threshold may be used to help set a minimal link quality for all assignments in the network.

At step 430, the receiver 8 may send a message indicating the available base stations 10 to the configuration station. The message may also contain the link quality of these base stations. In one implementation, the receiver 8 may temporarily associate to the base station 10 and send the message to that base station 10. The base station 10 may then forward the message to the configuration station. Step 430 may correspond to step 320 described above. The available base stations may be the base stations 10 with a link quality greater than the pre-determined threshold.

At step 440, the receiver 8 may receive a base station assignment from the configuration station. The base station assignment may be a message that indicates a selection of one of the available base stations 10. In one implementation, the configuration station may send a message to each base station 10 that includes the list of assigned receivers. In turn, the base stations 10 may broadcast their lists or send a message to each assigned receiver. The receivers 8 that receive this information may associate to their assigned base stations.

FIG. 5 illustrates a data flow diagram of a method 500 for configuring a wireless seismic data acquisition network in accordance with implementations described herein. The method 500 may formulate the assignment of the base stations 10 to the receivers 8 as a combinatorial optimization problem. Combinatorial optimization is a branch of optimization in mathematics in which there are a finite number of feasible configurations and the goal is to find the best configuration according to an objective.

In the method 500, a feasible configuration may be the assignment of the base stations 10 to the receivers 8 that meets the constraints 510. The constraints 510 may be conditions that constrain the number of choices for the assignment. The objectives 520 may be optimizations that select a best assignment according to the goals of the objectives 520.

The potential assignments 530 may be all potential assignment configurations between the receivers 8 and their available base stations 10. A potential assignment may have link quality higher than the threshold. From these inputs, the combinatorial optimization process 540 may produce a selected assignment 550, i.e., the best assignment according to the goals of the objectives 520.

Accordingly, constraints 510, objectives 520, and potential assignments 530 may be input to a combinatorial optimization process 540. The constraints 510 may include assigning only one base station 10 to each receiver 8, and assigning the base stations 10 to the receivers such that the capacity for the base stations 10 is not exceeded.

The objectives 520 may include fulfilling the constraints 510. However, fulfilling the constraints 510 may not provide an assignment of high quality according to certain objectives. As such, a second objective may be input. The second objective may include maximizing the total link quality between the receivers 8 and the base stations 10; maximizing the link quality of the lowest quality link between the receivers 8 and the base stations 10; and maximizing the available capacity on the most used base station 10. The link quality may be the signal strength of each link between the base stations 10 and their assigned receivers 8.

The constraints 510 and objectives 520 may be functions whose input is one of the potential assignments 530, and whose output is a real number. In terms of the constraints 510, the real number may indicate whether a particular assignment meets the constraints 510. In terms of the objectives 520, the real number may be a value that the objective 520 is formulated to optimize. For example, in the scenario where the objective 520 is to maximize the total link quality, the real number may represent the total link quality. In such a scenario, the assignment that produces the highest value of total link quality may be the selected assignment 550.

Many known algorithms can be used to solve a combinatorial optimization problem. However, the performance of each algorithm may vary depending on the nature of the problem. The first obvious algorithm is exhaustive search which explores all feasible configurations and then selects the best. However, such an approach may not be scalable with large problem. Consequently, the use of special mathematical tools may be needed to perform the assignment in real-time. Modeling this optimization problem for use with an efficient mathematical tool is not obvious as shown in the following paragraphs. In one implementation, the objectives 510 and constraints 520 may be expressed in a binary linear programming form.

In mathematics, linear programming is a technique for optimization of a linear objective function, subject to linear equality and linear inequality constraints. Informally, linear programming determines the way to achieve the best outcome in a given mathematical model given some list of requirements (objectives and constraints) represented as linear equations. Binary linear programming (BIP) is the special case of linear programming where variables are required to be 0 or 1.

If an optimization problem can be expressed in the following form, it is called linear programming (LP):

Minimize (or maximize) Z=c₁xₘ₊₁+c₂xₘ₊₂+. . . +cₙxₘ₊ₙ+c₀

subject to linear constraints

x₁=a₁₁xₘ₊₁+a₁₂xₘ₊₂+. . . +a₁ₙxₘ₊ₙ

x₂=a₂₁xₘ₊₁+a₂₂xₘ₊₂+. . . +a₂ₙxₘ₊ₙ

. . .

xₘ=aₘ₁xₘ₊₁+aₘ₂xₘ₊₂+. . . +aₘₙxₘ₊ₙ

and bounds of variables

l₁≦x₁≦u₁

l₂≦x₂≦u₂

. . .

lₘ₊ₙ≦xₘ₊ₙ≦uₘ₊ₙ

where a₁₁, a₁₂, . . . , aₘₙ; c₀, c₁, c₂, . . . , cₙ; l₁, l₂, . . . , lₘ₊ₙ; u₁, u₂, . . . , uₘ₊ₙ are constants and x₁, x₂, . . . , xₘ₊ₙ are variables; and

Z—objective function

x₁, x₂, . . . , xₘ—auxiliary variables

xₘ₊₁, xₘ₊₂, . . . , xₘ₊ₙ—structural variables

c₁, c₂, . . . , cₙ—objective coefficients

c₀—constant term of the objective function

a₁₁, a₁₂, . . . , aₘₙ—constraint coefficients

l₁, l₂, . . . , lₘ₊ₙ—lower bounds of constraints

u₁, u₂, . . . , uₘ₊ₙ—upper bounds of constraints

Bounds of variables can be finite as well as infinite. Further, lower and upper bounds can be equal to each other. When some of the structural variables are required to be integer, the form is called “mixed integer linear programming (MIP)”. If the integer variables are binary, the form is binary linear programming (BLP).

When a problem is expressed in MIP form, there are a number of known algorithms for solving it, such as “cutting plane method”, “branch and bound”, “branch and cut”, “branch and price”. These algorithms are well known and their implementations in software are widely available. To use such software, one performs an enumeration on the set of structural variables in the original problem and supplies the corresponding coefficients to the said software.

The following notation will be used to describe the objectives 510 and constraints 520 in BLP form:

### Inputs

Nₜ—the number of terminals/receivers 8
N_{b}—the number of base stations 10
Cⱼ—the capacity for base station with an index j
qᵢⱼ—the link quality between receiver of index i and base station of index j, where qᵢⱼ=0 if there is no link
T—the link quality threshold
S—potential assignments 530

### Outputs

Xᵢⱼ—a binary variable with a value of 1 when the base station of index j is assigned to the receiver of index i.

The selected assignment 550 may be expressed as a set of Xᵢⱼ for all indices i from 1 to Nₜ, and all indices j from 1 to N_{b}. S contains variables Xᵢⱼ corresponding to potential assignments. Variables outside of the set S have value 0. For example, if Nₜ=2 and N_{b}=2, the selected assignment 550 may contain the values of X₁₁, X₁₂, X₂₁ and X₂₂. In one scenario, the base station with index 1 may be assigned to the receiver with an index 1. Additionally, the base station with index 2 may be assigned to the receiver with an index 2. In such a scenario, X₁₁=1, X₁₂=0, X₂₁=0 and X₂₂=1.

In one implementation, the objective is to fulfill the constraints 510, the objective function Z is 0. The structural variables for this implementation are variable Xᵢⱼ in the set S. The first constraint may be to assign only one base station 10 to each receiver 8. Given the definition of Xᵢⱼ, the number of base stations 10 that the receiver of index 1 is assigned to is the sum, (X₁₁+X₁₂+. . . X_{1Nb}). Further, we can remove the variables Xᵢⱼ outside the set S. As such, the linear form that fulfills this constraint 510 may be expressed as follows:

$${\sum }_{j \vert {X}_{ij} ∈ S} {X}_{ij} = 1 , for all i from 1 to {N}_{t}$$

Another constraint is to limit the number of receivers to which the base station 10 is assigned to the capacity of the base station 10. As such, the linear form that fulfills this constraint 510 may be expressed as follows:

$${\sum }_{i \vert {X}_{ij} ∈ S} {X}_{ij} \leq {C}_{j} , for all j from 1 to {N}_{b}$$

Once the objective of fulfilling the constraints 510 has been fulfilled, the second objective may be applied to the process 540 to produce a selected assignment 550 of good quality according to the second objective.

In one implementation, the second objective may be to maximize the link quality between the receivers 8 and the base stations 10. In such an implementation, the link quality may be expressed as a numeric quantity. Accordingly, maximizing the link quality between the receivers 8 and the base stations may include maximizing the sum of link qualities between all the receivers and their assigned base stations.

For example, the network may have two base stations 10 and two receivers 8. Both base stations 10 may have a capacity of one receiver 8. The threshold may be one. Additionally, the link qualities may be q₁₁=3, q₁₂=1, q₂₁=10, q₂₂=4.

In such a scenario, the selected assignment 550 should be {X₁₁=0, X₁₂=1, X₂₁=1, X₂₂=0}. This configuration gives the highest link quality sum: (q₁₂+q₂₁=11).

The structural variables in this implementation may be the same as in the previous implementation. In the following notation, j1 is the index of the base station 10 assigned to the receiver of index 1, j2 is the index of the base station 10 assigned to the receiver of index 2, etc. As such, the sum of link qualities can be expressed as:

Z=q₁₍ⱼ₁₎+q₂₍ⱼ₂₎+. . . +q_{N}_{ₜ}_{j(N}_{ₜ}₎

For receiver with index 1, the variable X₁₍ⱼ₁₎ may equal 1. Accordingly, all other variables X₁ⱼ are 0, therefore:

$$\begin{matrix}{q}_{1 ( j 1 )} = {q}_{1 ( j 1 )} {X}_{1 ( j 1 )} \\ = {q}_{11} {X}_{11} + {q}_{12} {X}_{12} + ⋯ + {q}_{1 ( Nb )} {X}_{1 ( Nb )} \\ = {\sum }_{( j \vert {X}_{1 j} ∈ S )} {q}_{1 j} {X}_{1 j}\end{matrix}$$

As such, the linear form that fulfills this objective 520 may be expressed as maximizing:

$$z = {\sum }_{j \vert {X}_{1 j} ∈ S} {q}_{1 j} {X}_{1 j} + {\sum }_{j \vert {X}_{2 j} ∈ S} {q}_{2 j} {X}_{2 j} + ⋯ = {\sum }_{i , j \vert {X}_{ij} ∈ S} {q}_{ij} {X}_{ij}$$

In another implementation, the second objective may be to maximize the link quality of the lowest quality link between the receivers 8 and the base stations 10. In the scenario described above with two base stations 10 and two receivers 8, the selected assignment is 550 may be {X₁₁=0, X₁₂=1, X₂₁=1, X₂₂=0} to get maximum total link quality.

However, the link between the receiver of index 1 and the base station of index 2 may have very low quality. In this example, q₁₂=1. If instead, the second objective is to maximize the worst link quality, the selected assignment 550 may be {X₁₁=1, X₁₂=0, X₂₁=0, X₂₂=1}. The total link quality is lower (qᵢᵢ q₂₂=7). However, the worst link quality (q₁₁=3) is better than in previous case (q₁₂=1).

In the following discussion, W represents the worst link quality among the assigned receiver-base station pairs, where W is a positive real number. In this implementation, in addition to the set S of variables Xᵢⱼ, we introduce W as a new structural variable. The objective for this implementation is to maximize Z=W. It has linear form. Accordingly,

W≦q₁₍ⱼ₁₎

W≦q₂₍ⱼ₂₎

. . .

W≦q_{Nt(jNt)}

As stated previously,

$${q}_{1 ( j 1 )} = {\sum }_{( j \vert {X}_{1 j} ∈ S )} {q}_{1 j} {X}_{1 j}$$

$$Hence , \\ W \leq {\sum }_{j \vert {X}_{ij} ∈ S} {q}_{ij} {X}_{ij} , for all i from 1 to {N}_{t}$$

which can also be expressed as:

$${\sum }_{j \vert {X}_{ij} ∈ S} {q}_{ij} {X}_{ij} - W \geq 0 , for all i from 1 to {N}_{t}$$

Inversely, for a particular configuration, the maximum value of W satisfying the above Nₜ constraints may be the minimum link quality among the assignments. Thus, the global maximum value of W for all configurations may provide the selected assignment 550 with the maximized worst link quality. In this implementation, the above inequations are additional constraints in addition to constraints on capacity and unique assignment.

In another implementation, the objective may be to maximize the available capacity on the most used base station 10. This implementation can be used when base stations 10 have the same capacity, i.e., C. For example, any particular assignment will include a base station assigned to the most receivers 8. That base station may have a maximum number of receivers 8 for which the base station can transfer data. The objective for each assignment is to maximize the difference between the maximum number of receivers that the base station can transfer data and the number of receivers 8 to which that base station is assigned.

In the following discussion, F represents this difference. F is also referred to herein as free channels. Additionally, F may be real and non-negative. In this implementation, the structural variables are Xᵢⱼ in the set S and the variable F. The objective is to maximize Z=F. Accordingly, for a base station of index j, the number of free channels may be:

$$C - {\sum }_{i \vert {X}_{ij} ∈ S} {X}_{ij}$$

For a specific assignment, if F is the number of free channels on the most used base station, then:

$$F \leq C - {\sum }_{i \vert {X}_{ij} ∈ S} {X}_{ij} , for all j from 1 to {N}_{b}$$

Inversely, for a particular configuration, the maximum value of F satisfying these N_{b} inequations may also be the minimum number of free channels among the base stations. Thus, the above inequations are necessary and sufficient to define F. The above inequations may be re-written as:

$${\sum }_{i \vert {X}_{ij} ∈ S} {X}_{ij} + F \leq C , for all j from 1 to {N}_{b}$$

In this implementation, the above inequations are additional constraints in addition to constraints on capacity and unique assignment.

After the initial network configuration, additional receivers 8 might be positioned in the survey area 2. Further, base stations may be added to the network for some receivers, or base stations might leave the network. In such a reconfiguration, the objective may be to minimize the number of assignment changes, and to get the best assignment according to some goals described above at the same time. The reason is that a change to existing assignments involves sending commands to the involved entities and that the service of the involved terminals may be temporarily lost. In the first step, a network change is reported to the configuration station by either terminals or base stations. Next, the central site uses the method 500 for only the terminals which need new assignment and the base stations which has unused capacity. This consists of a number of smaller steps:

Step 1: Exclude unaffected assignments from the new problem. If there are new terminals to be added, then all the current assignments are unaffected. If a base station fails, then all assignments not containing the said base station are unaffected.

Step 2: Include terminals that need new assignment. They are either new terminals or previously assigned to a failed base station.

Step 3: Update capacity of base stations. The new value is obtained by subtracting the number of terminals assigned previously from the old value.

Step 4: Use method 500 for the above set of terminals and base stations with a goal such as maximizing the total link quality, maximizing the worst link quality, maximizing the available quality of the most used base station.

This selection has two advantages. First, the size of the problem is smaller, i.e., the problem can be solved within a shorter execution time. Second, the new assignments can be optimized following one of the objectives discussed above. If the new problem has a solution, then the work is done. Otherwise, the next step is to use method 500 for a new problem involving all terminals and base stations in which the only objective may be to minimize the number of assignment changes.

In the following discussion the previous notation is maintained. More specifically, the index of receivers and base stations present previously in the network may be maintained, even if no longer in the network. For example, if in the past, the base station with index 5 was present and left, the index 5 may still correspond to that base station in the reconfigured network. This ensures that the base station with index 6 in the previous selected assignment 550 still has the index 6 in the new selected assignment 550. In the following discussion, the variable Xᵢⱼ refers to the assignments in the previously selected assignment 550. Variables X′ᵢⱼ refers to the new assignments.

However, since no receiver may associate with base stations that leave the network, all the variables X′ᵢ₅, i=1 . . . Nₜ, for example, may equal 0 and may be removed from the potential assignments 530.

Similarly, if a receiver of index 1 was present and left, the receiver can no longer be assigned to any base stations in the reconfigured network. Accordingly, all variables X′₁ⱼ, j=1 . . . N_{b}, may equal 0 and may be removed from the potential assignments 530.

New receivers and base stations may be assigned indices according to the previous size of the network. For example, if there were 1000 receivers in the past, a new receiver may have index 1001 even though some receivers may have left the network.

Accordingly, the value of Xᵢⱼ may be equal to 0 if i or j corresponds to a new receiver or a new base station, because this assignment did not exist in the previous selected assignment 550.

The set of structural variables for this implementation is the set S′ containing X′ᵢⱼ corresponding to potential assignments. The constraints in this implementation still include respecting capacity and unique assignment. The linear form of these constraints has been discussed earlier.

Also, it should be noted that there may be an assignment change for a couple (receiver i assigned to base station j) if X′ᵢⱼ # Xᵢⱼ. Accordingly, (X′ᵢⱼ−Xᵢⱼ)² may only have two values: either 0 or 1. Therefore, the total number of assignment changes is minimized when the following function is minimized.

$$f = {\sum }_{i , j \vert {X}_{ij} ∈ {S}^{′}} {( {X}_{ij}^{′} - {X}_{ij} )}^{2}$$

In order to use binary linear programming, this function must be transformed to a linear form. First, one has

(X′ᵢⱼ−Xᵢⱼ)²=X′²ᵢⱼ−2X′ᵢⱼXᵢⱼ+X²ᵢⱼ

Since X′ᵢⱼ and Xᵢⱼ are binary, then:

X′hd ij²=X′ᵢⱼ

Xᵢⱼ²=Xᵢⱼ

Hence,

(X′ᵢⱼ−Xᵢⱼ)²=X′ᵢⱼ−2X′ᵢⱼXᵢⱼ+Xᵢⱼ=(1−2Xᵢⱼ)X′ᵢⱼ+Xᵢⱼ

By ignoring the constant member in the last addition, the objective is to minimize the following linear function:

$$z = {\sum }_{i , j \vert {X}_{ij}^{′} ∈ {S}^{′}} ( 1 - 2 {X}_{ij} ) {X}_{ij}^{′}$$

FIG. 6 illustrates a configuration station 600, into which implementations of various technologies described herein may be implemented. The configuration station 600 may be a computing system that includes one or more system computers 630, which may be implemented as any conventional personal computer or server. However, those skilled in the art will appreciate that implementations of various technologies described herein may be practiced in other computer system configurations, including hypertext transfer protocol (HTTP) servers, hand-held devices, multiprocessor systems, microprocessor-based or programmable consumer electronics, network PCs, minicomputers, mainframe computers, and the like.

The system computer 630 may be in communication with disk storage devices 629, 631, and 633, which may be external hard disk storage devices. It is contemplated that disk storage devices 629, 631, and 633 are conventional hard disk drives, and as such, will be implemented by way of a local area network or by remote access. Of course, while disk storage devices 629, 631, and 633 are illustrated as separate devices, a single disk storage device may be used to store any and all of the program instructions, measurement data, and results as desired.

In one implementation, network data about the receivers 8 and the base stations 10 may be stored in disk storage device 631. The system computer 630 may retrieve the appropriate data from the disk storage device 631 to process network data according to program instructions that correspond to implementations of various technologies described herein. The program instructions may be written in a computer programming language, such as C++, Java and the like. The program instructions may be stored in a computer-readable medium, such as program disk storage device 633. Such computer-readable media may include computer storage media and communication media.

Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the system computer 630.

Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. Combinations of any of the above may also be included within the scope of computer readable media.

In one implementation, the system computer 630 may present output primarily onto graphics display 627, or alternatively via printer 628. The system computer 630 may store the results of the methods described above on disk storage 629, for later use and further analysis. The keyboard 626 and the pointing device (e.g., a mouse, trackball, or the like) 625 may be provided with the system computer 630 to enable interactive operation.

The system computer 630 may be located at a data center remote from the area of interest. The system computer 630 may be in communication with a wireless seismic data acquisition network (either directly or via a recording unit, not shown), to receive signals indicative of the network data. These signals, after conventional formatting and other initial processing, may be stored by the system computer 630 as digital data in the disk storage 631 for subsequent retrieval and processing in the manner described above. While FIG. 6 illustrates the disk storage 631 as directly connected to the system computer 630, it is also contemplated that the disk storage device 631 may be accessible through a local area network or by remote access. Furthermore, while disk storage devices 629, 631 are illustrated as separate devices for storing input data and analysis results, the disk storage devices 629, 631 may be implemented within a single disk drive (either together with or separately from program disk storage device 633), or in any other conventional manner as will be fully understood by one of skill in the art having reference to this specification.

While the foregoing is directed to implementations of various technologies described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for configuring a wireless seismic acquisition network, comprising:
positioning a plurality of seismic receivers over a survey area in a fixed pattern;
receiving a first message from the receivers, wherein the first message indicates one or more base stations that are available for transferring seismic data from the receivers to a recording system;
receiving a second message from the base stations, wherein the second message indicates a maximum number of receivers for which each of the base stations can transfer seismic data; and
assigning one of the base stations to each receiver without exceeding the maximum number.

2. The method of claim 1, wherein the first message comprises a link quality of the one or more base stations.

3. The method of claim 2, further comprising assigning the base stations to the receivers such that a sum of link qualities between all the receivers and their assigned base stations is maximized.

4. The method of claim 2, further comprising:
determining a link having a worst link quality of all links between the base stations and the receivers; and
assigning the base stations to the receivers such that the worst link quality is maximized.

5. The method of claim 1, further comprising:
identifying a base station that has been assigned to a highest number of receivers; and
assigning the base stations to the receivers such that a difference between the maximum number of receivers for the identified base station and the highest number is maximized.

6. The method of claim 1, further comprising:
receiving an indication that one of the base stations is unavailable; and
assigning one or more receivers having been assigned to the unavailable base station to a remainder of available base stations such that assignment changes to the available base stations are minimized.

7. The method of claim 1, further comprising:
positioning one or more additional seismic receivers over the survey area in the fixed pattern;
receiving an indication that the additional receivers are added to the network; and
assigning the base stations to the additional receivers such that assignment changes to the base stations are minimized.

8. The method of claim 1, wherein assigning the one of the base stations comprises:
formulating the assignment as a combinatorial optimization problem having a first constraint, a second constraint, and a first objective, wherein the first constraint comprises assigning the one of the base stations to each receiver, the second constraint comprises avoiding exceeding the maximum number for the one of the base stations, and the first objective comprises fulfilling the first constraint and the second constraint.

9. The method of claim 8, wherein the first objective is fulfilled by using one or more binary linear programming algorithms comprising constraints
$${\sum }_{j \vert {X}_{ij} ∈ S} {X}_{ij} = 1 ,$$
for all i from 1 to Nₜ, and constraints
$${\sum }_{i \vert {X}_{ij} ∈ S} {X}_{ij} \leq {C}_{j} ,$$
for all j from 1 to N_{b}, wherein i is an index that identifies one of the receivers, j is an index that identifies one of the base stations, Xᵢⱼ is a binary variable with a value of 1 when a base station j is assigned to a receiver i, and a value of 0 when the base station j is not assigned to the receiver i, Nₜ is a number of the receivers, N_{b} is a number of the base stations, Cⱼ is the maximum number for base station j, and S is a set of all potential assignments between the receivers and their available base stations.

10. The method of claim 3, wherein assigning the base stations comprises:
formulating the assignment as a combinatorial optimization problem having a first constraint, a second constraint, a first objective, and a second objective, wherein the first constraint comprises assigning the one of the base stations to each receiver, the second constraint comprises avoiding exceeding the maximum number for the one of the base stations, the first objective comprises fulfilling the first constraint and the second constraint, and the second objective comprises assigning the base stations to the receivers such that a sum of link qualities between all the receivers and their assigned base stations is maximized.

11. The method of claim 10, wherein the first objective and the second objective are fulfilled by using one or more binary linear programming algorithms comprising constraints
$${\sum }_{j \vert {X}_{ij} ∈ S} {X}_{ij} = 1 ,$$
for all i from 1 to Nₜ, constraints
$${\sum }_{i \vert {X}_{ij} ∈ S} {X}_{ij} \leq {C}_{j} ,$$
for all j from 1 to N_{b}, and an objective function to maximize Σ_{i,j|X}_{ᵢⱼ}_{εS} qᵢⱼXᵢⱼ, wherein i is an index that identifies one of the receivers, j is an index that identifies one of the base stations, Xᵢⱼ is a binary variable with a value of 1 when a base station j is assigned to a receiver i, and a value of 0 when the base station j is not assigned to the receiver i, Nₜ is a number of the receivers, N_{b} is a number of the base stations, Cⱼ is the maximum number for base station j, S is a set of all potential assignments between the receivers and their available base stations, Z is the sum of the link qualities, and qᵢⱼ is a link quality between the receiver i and the base station j.

12. The method of claim 4, wherein assigning the base stations comprises:
formulating the assignment as a combinatorial optimization problem having a first constraint, a second constraint, a first objective, and a second objective, wherein the first constraint comprises assigning the one of the base stations to each receiver, the second constraint comprises avoiding exceeding the maximum number for the one of the base stations, the first objective comprises fulfilling the first constraint and the second constraint, and the second objective comprises assigning the base stations to the receivers such that the worst link quality is maximized.

13. The method of claim 12, wherein the first objective and the second objective are fulfilled by using one or more binary linear programming algorithms comprising constraints
$${\sum }_{j \vert {X}_{ij} ∈ S} {X}_{ij} = 1 ,$$
for all i from 1 to Nₜ, constraints
$${\sum }_{i \vert {X}_{ij} ∈ S} {X}_{ij} \leq {C}_{j} ,$$
for all j from 1 to N_{b}, constraints Σ_{j|X}_{ᵢⱼ}_{εS} qᵢⱼXᵢⱼ−W≧0, for all i from 1 to Nₜ, and an objective function to maximize W, wherein i is an index that identifies one of the receivers, j is an index that identifies one of the base stations, Xᵢⱼ is a binary variable with a value of 1 when a base station j is assigned to a receiver i, and a value of 0 when the base station j is not assigned to the receiver i, Nₜ is a number of the receivers, N_{b} is a number of the base stations, Cⱼ is the maximum number for base station j, S is a set of all potential assignments between the receivers and their available base stations, qᵢⱼ is a link quality between the receiver i and the base station j, and W is a non-negative real variable which represents the worst link quality.

14. The method of claim 5, wherein assigning the base stations comprises:
formulating the assignment as a combinatorial optimization problem having a first constraint, a second constraint, a first objective, and a second objective, wherein the first constraint comprises assigning the one of the base stations to each receiver, the second constraint comprises avoiding exceeding the maximum number for the one of the base stations, the first objective comprises fulfilling the first constraint and the second constraint, and the second objective comprises assigning the base stations to the receivers such that the difference between the maximum number for the identified base station and the number of receivers that the identified base station is assigned to is maximized.

15. The method of claim 14, wherein the first objective and the second objective are fulfilled by using one or more binary linear programming algorithms comprising constraints
$${\sum }_{j \vert {X}_{ij} ∈ S} {X}_{ij} = 1 ,$$
for all i from 1 to Nₜ, constraints
$${\sum }_{i \vert {X}_{ij} ∈ S} {X}_{ij} \leq {C}_{j} ,$$
for all j from 1 to N_{b}, constraints
$${\sum }_{i \vert {X}_{ij} ∈ S} {X}_{ij} + F \leq {C}_{j} ,$$
for all j from 1 to N_{b}, and an objective function to maximize F, wherein i is an index that identifies one of the receivers, j is an index that identifies one of the base stations, Xᵢⱼ is a binary variable with a value of 1 when a base station j is assigned to a receiver i, and a value of 0 when the base station j is not assigned to the receiver i, Nₜ is a number of the receivers, N_{b} is a number of the base stations, Cⱼ is the maximum number for base station j, S is a set of all potential assignments between the receivers and their available base stations, and F is non-negative real variable that represents a number of the receivers to which the identified base station can be further assigned to without exceeding the maximum number for the one of the base stations.

16. The method of claim 6, wherein assigning the base stations comprises:
formulating the assignment as a combinatorial optimization problem having a first constraint, a second constraint, a first objective, and a second objective, wherein the first constraint comprises assigning the one of the base stations to each receiver, the second constraint comprises avoiding exceeding the maximum number for the one of the base stations, the first objective comprises fulfilling the first constraint and the second constraint, and the second objective comprises assigning one or more receivers having the unavailable base station assigned to a remainder of available base stations such that assignment changes to the available base stations are minimized.

17. The method of claim 16, wherein the first objective and the second objective are fulfilled by using one or more binary linear programming algorithms comprising constraints
$${\sum }_{j \vert {X}_{ij}^{′} ∈ {S}^{′}} {X}_{ij}^{′} = 1 ,$$
for all i from 1 to Nₜ, constraints
$${\sum }_{i \vert {X}_{ij}^{′} ∈ {S}^{′}} {X}_{ij}^{′} \leq {C}_{j} ,$$
for all j from 1 to N_{b}, and an objective function to minimize
$${\sum }_{i , j \vert {X}^{′} ij ∈ {S}^{′}} ( 1 - 2 {X}_{ij} ) {{X}^{′}}_{ij} ,$$
wherein i is an index that identifies one of the receivers, j is an index that identifies one of the base stations, Xᵢⱼ is a binary value with a value of 1 when a base station j was previously assigned to a receiver i, and a value of 0 when a base station j was not previously assigned to a receiver i, X′ᵢⱼ is a binary variable with a value of 1 when a base station j is assigned to a receiver i, and a value of 0 when the base station j is not assigned to the receiver i, Nₜ is a number of the receivers, N_{b} is a number of the base stations, Cⱼ is the maximum number for base station j, S′ is a set of all potential assignments between the receivers and their available base stations, Xᵢⱼ is 1 and X′ᵢⱼ is 0, when the base station j has an assignment change to the receiver i, and Z is a sum of the assignment changes.

18. The method of claim 7, wherein assigning the base stations comprises:
formulating the assignment as a combinatorial optimization problem having a first constraint, a second constraint, a first objective, and a second objective, wherein the first constraint comprises assigning the one of the base stations to each receiver, the second constraint comprises avoiding exceeding the maximum number for the one of the base stations, the first objective comprises fulfilling the first constraint and the second constraint, and the second objective comprises assigning the base stations such that assignment changes to the base stations are minimized.

19. The method of claim 18, wherein the first objective and the second objective are fulfilled by using one or more binary linear programming algorithms comprising constraints
$${\sum }_{j \vert {X}_{ij}^{′} ∈ {S}^{′}} {X}_{ij}^{′} = 1 ,$$
for all i from 1 to Nₜ, constraints
$${\sum }_{i \vert {X}_{ij}^{′} ∈ {S}^{′}} {X}_{ij}^{′} \leq {C}_{j} ,$$
for all j from 1 to N_{b}, and an objective function to minimize
$${\sum }_{i , j \vert {X}^{′} ij ∈ {S}^{′}} ( 1 - 2 {X}_{ij} ) {{X}^{′}}_{ij} ,$$
wherein i is an index that identifies one of the receivers, j is an index that identifies one of the base stations, Xᵢⱼ is a binary value with a value of 1 when a base station j was previously assigned to a receiver i, and a value of 0 when a base station j was not previously assigned to a receiver i, X′ᵢⱼ is a binary variable with a value of 1 when a base station j is assigned to a receiver i, and a value of 0 when the base station j is not assigned to the receiver i, Nₜ is a number of the receivers, N_{b} is a number of the base stations, Cⱼ is the maximum number for base station j, S′ is a set of all potential assignments between the receivers and their available base stations, Xᵢⱼ is 1 and X′ᵢⱼ is 0, when the base station j has an assignment change to the receiver i, and Z is a sum of the assignment changes.

20. A system for acquiring seismic data, comprising:
a plurality of seismic receivers;
one or more base stations; and
a configuration station, comprising:
a processor; and
a memory containing computer-executable instructions which when executed by the processor, cause the configuration station to:
receive a first message from the receivers, wherein the first message indicates one or more base stations that are available for transferring seismic data from the receivers to a recording system, and indicates a link quality of the base stations;
receive a second message from the base stations, wherein the second message indicates a maximum number of the receivers for which each of the base stations can transfer seismic data;
assign one of the base stations to each receiver without exceeding the maximum number; and
assign the base stations to the receivers such that a sum of link qualities between all the receivers and their assigned base stations is maximized;
wherein the base stations are assigned by formulating the assignment as a combinatorial optimization problem having a first constraint, a second constraint, a first objective, and a second objective, wherein the first constraint comprises assigning the one of the base stations to each receiver, the second constraint comprises avoiding exceeding the maximum number for the one of the base stations, the first objective comprises fulfilling the first constraint and the second constraint, and the second objective comprises assigning the receivers, and wherein the first objective and the second objective are fulfilled by using one or more binary linear programming algorithms comprising constraints
$${\sum }_{j \vert {X}_{ij} ∈ S} {X}_{ij} = 1 ,$$
for all i from 1 to Nₜ, constraints
$${\sum }_{i \vert {X}_{ij} ∈ S} {X}_{ij} \leq {C}_{j} ,$$
for all j from 1 to N_{b}, and an objective function to maximize Σ_{i,j|X}_{ᵢⱼ}_{εS} qᵢⱼXᵢⱼ, wherein i is an index that identifies one of the receivers, j is an index that identifies one of the base stations, Xᵢⱼ is a binary variable with a value of 1 when a base station j 1 is assigned to a receiver i, and a value of 0 when the base station j is not assigned to the receiver i, Nₜ is a number of the receivers, N_{b} is a number of the base stations, Cⱼ is the maximum number for base station j, S is a set of all potential assignments between the receivers and their available base stations, Z is the sum of the link qualities, and qᵢᵢ is a link quality between the receiver i and the base station j.

21. A method for assigning a base station to a receiver, comprising:
receiving one or more wireless signals from one or more base stations disposed in a fixed pattern over a seismic survey area;
determining one or more of the wireless signals that exceed a predetermined link quality threshold;
sending a first message to a configuration station, wherein the first message indicates the base stations corresponding to the one or more of the wireless signals that exceed the predetermined link quality threshold; and
receiving a second message from the configuration station indicating a selection of one of the base stations corresponding to the one or more of the wireless signals that exceed the predetermined link quality threshold.

22. The method of claim 21, further comprising sending seismic data only to the one of the base stations.
